(19) United States
(12) Patent Application Publication
(10) Pub. No.: US 2025/0295099 A1
(43) Pub. Date: Sep. 25, 2025

(54) Fishing Leader Organizer and Storage Board

(71) Applicant: Brandon Joseph Hatch, Colville, WA (US)

(72) Inventor: Brandon Joseph Hatch, Colville, WA (US)

(21) Appl. No.: 19/034,539

(22) Filed: Jan. 22, 2025

Related U.S. Application Data
(60) Provisional application No. 63/747,008, filed on Jan. 19, 2025.

(51) Int. Cl. A01K 97/06

(52) U.S. Cl. CPC A01K 97/06

(57) ABSTRACT

A leader board for pre-tied fishing leaders includes a foam layer bonded to a backing layer. Partial-depth slits extend from the front surface to a depth short of the rear surface of the foam layer, preventing hook protrusion. Adjacent to each slit is a vertical column of holes in at least two different diameters, the holes extending completely through the foam layer and the backing layer allowing anglers to secure plain line or swivel-equipped line by wrapping and threading through the appropriately sized hole.

### BACKGROUND

### Field of the Invention

The present invention relates generally to storage devices for fishing tackle, particularly for organizing pre-tied fishing leaders. More specifically, the invention is directed to fishing tackle holders or organizers designed for storing lines, hooks, and lures and to boards or racks that secure hooks, lines, or terminal tackle for convenient transport and use.

### Description of Related Art

Anglers routinely use foam boards or other holders to store pre-tied fishing leaders. However, many conventional leader boards cut their slits entirely through the foam, allowing hooks to protrude from the rear surface. This can cause entanglement with other tackle or lead to unwanted snags. Additionally, many designs do not include systematic line-locking holes or a backing layer that prevents rear-surface hook protrusion.

Jamarowicz (United States Patent Publication No. 2024/0381861) teaches a lure-packing device with multiple indentations for lines and lures. While it addresses storing various lure shapes, it does not teach partial-depth slits or a neoprene backing to stop hooks from exiting the board. Nor does it provide a vertical column of alternating hole sizes for both plain line and swivel-equipped line.

Smith (U.S. Pat. No. 9,320,267) teaches a terminal tackle holder made from foam with protruding ribs that secure hooks or pre-tied leaders. While Smith's device employs foam cutouts, it lacks partial-depth slits that remain short of the board's rear surface, does not utilize a neoprene backing, and does not include a series of different-diameter holes running the board's full height for line-locking.

Despite the existence of numerous tackle-storage products, many anglers still struggle with accidental hook protrusion, tangling of multiple leaders, and insufficient attachment options for lines with or without swivels. Traditional foam boards that cut slits entirely through the material often cause hooks to emerge from the opposite side, creating tangles or snags. Products without a neoprene or comparable backing may allow hooks to protrude, leading to unwanted entanglement or potential damage. Moreover, the absence of a systematically arranged set of holes for line-locking forces users to rely on external clips, tying off on edges, or single-size holes that do not accommodate differing terminal tackle dimensions.

There remains a need for a leader board that prevents hooks from protruding through the rear surface via partial-depth (non-through) slits, uses a neoprene backing on the foam for improved durability, water resistance, and slip prevention, and offers multiple hole diameters in a vertical or near-vertical arrangement beside each slit, enabling secure line locking for plain lines or swivel-equipped lines without tangling.

### SUMMARY

The present invention provides a leader board constructed of a foam layer backed with neoprene. In one instance of the invention the foam layer is an ethylene-vinyl acetate (EVA) foam layer. Slits are cut from the front surface of the foam to a depth short of the rear surface, preventing hooks from emerging through the board. Arranged adjacent to each slit is a vertical column of holes that vary in diameter—at least two distinct sizes—to accommodate both bare line and lines equipped with swivels or other terminals. By inserting the hook into the partial-depth slit, wrapping the leader around the board, and threading the free end of the line through a suitably sized hole, anglers can secure their lines without having hooks or swivels protrude from the back.

The foam layer provides a compressible medium to hold hooks securely, while the neoprene backing ensures no hook penetrates the rear surface. Provision of partial-depth slits that extend only a portion of the foam thickness keep hooks contained within the foam. A column of holes extending substantially from the top edge to the bottom edge of the board are provided in at least two different diameters, a first set suitable for thin or bare line, and a second set suitable for swivel-equipped or thicker line.

The thickness and sizing of the foam layer may be varied as a matter of design choice. Although a preferred foam thickness of about 0.5-inch is often preferred, alternate thicknesses may be used. Similarly, specific hole diameters can vary based on user needs.

This combination overcomes common shortcomings in traditional boards by reducing tangles, ensuring hooks remain safely within the foam, and providing flexible tie-off points for varying leader-end attachments.

### BRIEF DESCRIPTION OF THE DRAWING FIGURES

FIG. 1 is a top view of the leader board, illustrating partial-depth slits and adjacent columns of differently sized holes.

FIG. 2 is a cross-sectional view of a leader board such as the one of FIG. 1 including a plurality of same-sized holes and shows how the slit terminates before reaching the neoprene backing, preventing hook protrusion.

FIG. 3 is a cross-sectional view of the leader board of FIG. 1 illustrating an alternative arrangement having different hole sizes, showing the adaptability of hole placement and shows both small and large sized holes interspersed between the slits.

FIG. 4 is flow diagram showing a method for fabricating the leader board in accordance with the present invention.

FIG. 5 is a flow diagram showing a method for using the leader board in accordance with the present invention.

### DETAILED DESCRIPTION

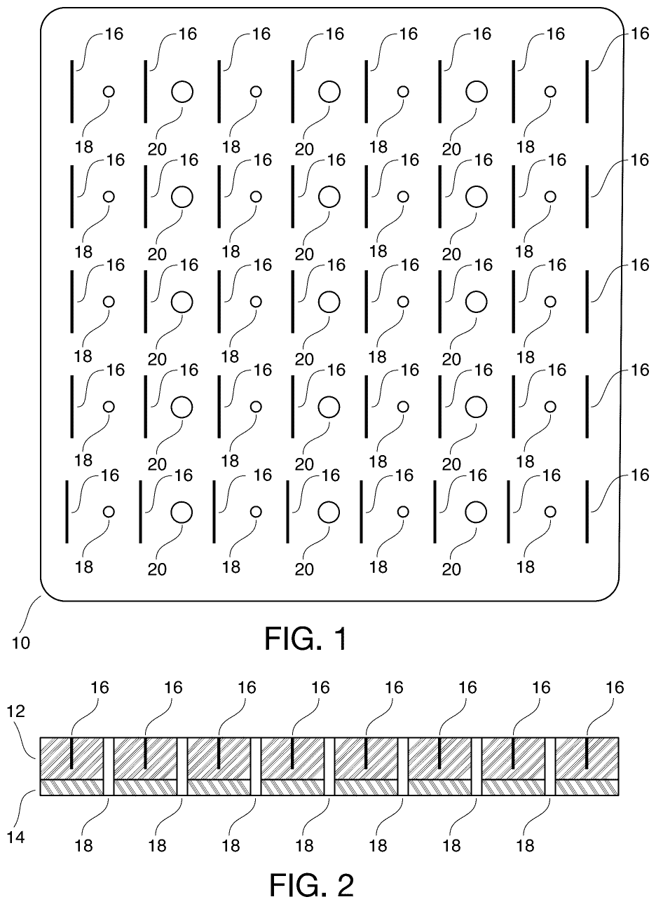

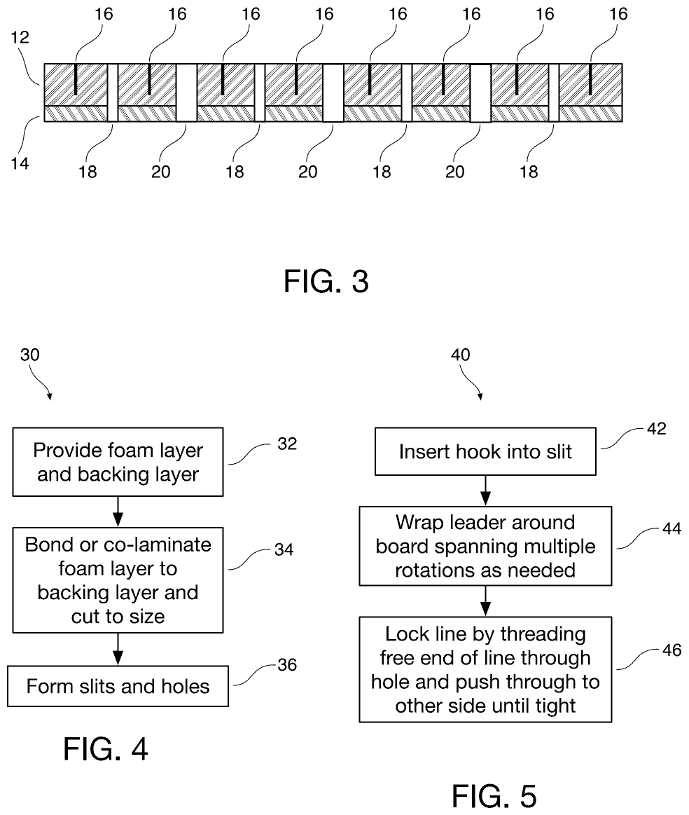

Referring first to FIGS. 1 and 2, the main body of the board 10 typically comprises a foam layer 12, having thicknesses that can vary (e.g., 0.375 to 0.75 inches, nominally about 0.5 inches). This range accommodates different fishing setups, with tighter spacing for smaller lines and wider spacing for heavier tackle or larger configurations. In one instance of the invention, ethylene-vinyl acetate (EVA) foam, known for its durability and flexibility is ideal for securely holding tackle without damage to the material or equipment.

A neoprene layer 14 is bonded or co-laminated to the rear surface of the foam layer 12 to provide slip resistance, water resistance, and to ensure that hooks or points do not emerge out the rear surface of the board 10.

As shown in FIG. 1, the foam layer 12 includes a plurality of slits 16. Each slit 16 extends from the front surface of the foam layer 12 toward the rear, stopping short of the neoprene layer 14 as shown in FIG. 2. The depth may be approximately 80-90% of the total foam thickness, leaving an uncut portion of the foam layer 12 that serves as a barrier. The slits 16 are formed to a depth that terminates before reaching the opposite surface to provide a secure storage solution that prevents tangles and maintains line integrity by preventing the ends of the hooks from protruding through the back surface of the board 10. Slit lengths can vary to accommodate different hook sizes; for example, one user might prefer a short 0.125-inch slit for small hooks, while another might require up to a 1-inch slit for larger hooks.

The spacing between slits 16 typically ranges from 0.5″ inch to 0.625″, depending on the intended application. This range is a common configuration for standard designs but may vary to accommodate specific user requirements or board sizes. The spacing ensures an optimal balance between secure line placement and efficient use of space. This range accommodates different fishing setups, with tighter spacing for smaller lines and wider spacing for heavier tackle or larger configurations.

As shown in FIG. 2, vertical or near-vertical column of holes is provided adjacent to each slit, the column of holes extending substantially the board's entire height. FIG. 2 shows a plurality of same-sized holes 18.

According to one instance of the invention, at least two hole diameters are provided, a first set of smaller diameter holes for bare line shown at reference numerals 18, and a second set of larger diameter holes shown at reference numerals 20 for lines equipped with swivels or other connectors. Typical diameters for the small holes 18 may range from about 0.03 to about 0.08 inches, while the larger holes 20 may range from about 0.125 to about 0.250 inches, though other dimensions may be used depending on application requirements. Exact diameters are not limited to particular numeric values; rather, they are sized as a matter of design choice to accommodate the range of lines or attachments a user may employ. While FIGS. 1 and 2 show alternating columns of small holes 18 and large holes 20, persons of ordinary skill in the art will appreciate that other combinations of positions of small holes 18 and large holes 20 are possible.

The holes 18 and 20 are typically spaced a short distance from the slits 16 (e.g., 0.25 inches) so that anglers can easily feed the free end of the line after wrapping. The number of holes 18 and 20 and their spacing is also a matter of design choice and can vary according to board size and user preference.

FIG. 4 is a flow diagram that shows an illustrative method 30 for fabricating a leader board in accordance with the present invention. At reference numeral 32 a foam layer and a backing layer are provided. At reference numeral 34 the foam layer and the backing layer are bonded or co-laminated together and the board is cut to size. At reference numeral 36 the slits are formed in the foam layer and the holes are formed through both the foam layer and the backing layer.

According to a method 40 of using the invention, shown in the flow diagram of FIG. 5, at reference numeral 42 the user inserts the hook into the partial-depth slit so that the hook point is fully contained within the foam, never breaking through the neoprene backing.

At reference numeral 44, the user then wraps the leader line around the board, spanning multiple rotations as needed.

After wrapping, at reference numeral 46 the line is locked by threading the free end of the line through one of the holes that best fits its terminal attachment and pushed through to the other side until it is tight. Smaller holes suit plain line, while larger holes accommodate swivels. Once pulled taut, friction and the geometry of the hole secure the line.

The present invention provides several advantages. There is no rear-surface hook protrusion because the slits do not extend completely through the body of the board, so hooks remain contained and cannot snag other tackle. the board is durable and slip-resistant. The backing helps prevent slippage on boat surfaces and resists water intrusion.

The board of the present invention provides tangle reduction because the multiple hole diameters and partial-depth slits keep lines neatly organized and prevent them from unraveling. The board is adaptable in that users can modify hole spacing, board dimensions, and slit lengths according to different fishing styles.

Alternative instances of the invention are contemplated. The board may be rectangular, square, circular, or any other shape without departing from the invention's scope.

Additional columns of holes can be introduced if desired, each with varying diameters to accommodate a range of lines or rigs.

While laser cutting is a presently preferred approach because it allows precise control of slit depth and hole placement, other processes such as die cutting or waterjet cutting can be used to form the slits and holes.

In each alternative, the core features—partial-depth foam slits, neoprene backing, and a series of holes in multiple diameters—remain consistent.

1. A leader board for storing pre-tied fishing leaders, comprising:
a body formed of a foam layer bonded to a backing layer;
at least one slit extending from a front surface of the foam layer toward a rear surface, the slit terminating at a depth that does not traverse the full foam thickness, thereby preventing a hook from emerging at the rear surface; and
a plurality of holes arranged adjacent to the slit, the plurality of holes extending through both the foam layer and the backing layer having.

2. The leader board of claim 1, wherein the EVA foam layer has a thickness of about 0.5 inches.

3. The leader board of claim 1, further comprising multiple slits spaced apart to store multiple pre-tied leaders, each slit flanked by at least one column of holes of varying diameters.

4. The leader board of claim 1, wherein the slit extends approximately 80-90% of the total thickness of the foam layer, leaving an uncut foam portion that prevents any portion of the hook from exiting the rear surface.

5. The leader board of claim 1, wherein the holes are spaced vertically substantially along an entire height of the board, providing multiple entry points for locking lines of varying lengths.

6. The leader board of claim 1, further comprising an outer shape selected from one of rectangular, square, circular, and irregular forms, wherein the slits and holes remain functionally arranged for storing fishing leaders.

7. A method of storing a pre-tied fishing leader on a leader board, comprising the steps of:
providing a board formed of a foam layer bonded to a backing, said board having at least one partial-depth slit that does not extend through a rear surface thereof;
inserting a fishing hook into the slit so it is retained within the foam layer;
wrapping the fishing leader around the board; and
threading a free end of the fishing leader through at least one hole in a column of holes adjacent to the slit, wherein at least two different hole diameters are provided to accommodate a range of terminal tackle configurations.

8. The method of claim 7, wherein the slit depth is defined by one of a laser, die-cut, manufacturing process that terminates short of the backing.

9. The method of claim 7, further comprising selecting a hole from a set of smaller-diameter holes to lock plain line and selecting a hole from a set of larger-diameter holes to lock line equipped with swivels or other connectors.

10. The method of claim 10, wherein multiple slits are provided, each slit having a corresponding set of at least two hole diameters arranged adjacent thereto, enabling independent storage of multiple pre-tied leaders on the same board.

11. The leader board of claim 1, wherein the foam layer is an ethylene-vinyl acetate (EVA) foam layer.

12. The leader board of claim 1 wherein the backing layer is a neoprene backing layer.

13. The leader board of claim 1 wherein the plurality of holes includes holes having at least two different diameters to accommodate fishing line alone and fishing line equipped with swivels or other terminal connectors

14. The method of claim 7, wherein providing a board formed of a foam layer bonded to a neoprene backing, comprises providing a board formed of an ethylene-vinyl acetate (EVA) foam layer.
